(19) United States
(12) Patent Application Publication
(10) Pub. No.: US 2015/0298134 A1
(43) Pub. Date: Oct. 22, 2015

(54) TRASH RECEIVING STRUCTURE FOR SHREDDER AND SHREDDER USING THE SAME

(71) Applicant: SAKAE CO., LTD., Tokyo (JP)

(72) Inventors: Yukihiro TAKEDA, Kodama-gun (JP); Yoshio MASUKO, Kodama-gun (JP); Koichi MATSUMOTO, Fujioka-shi (JP)

(73) Assignee: SAKAE CO., LTD., Tokyo (JP)

(21) Appl. No.: 14/688,495

(22) Filed: Apr. 16, 2015

(30) Foreign Application Priority Data
Apr. 17, 2014 (JP) 2014-085379

(51) Int. Cl. B02C 18/00

(52) U.S. Cl. CPC B02C 18/0007; B02C 2018/0046

(57) ABSTRACT

Provided are a shredder and a trash receiving structure for a shredder, preventing the particles from being scattered to the surroundings, thereby facilitating the post-process on the particles. The trash receiving structure for a shredder includes: a shredder casing (1) having a shredding mechanism (11) and a trash container (12); a partition frame member (2) including a plurality of beams (3) assembled to each other with clearances (4) secured between the plurality of beams (3) to define a setting space for the trash container (12), the partition frame member (2) being configured such that the trash container (12) is set thereon to be insertable to and removable from the shredder casing (1); and a tray-like catching member (6) set to be insertable to and removable from a space portion between the bottom portion of the shredder casing (1) and the partition frame member (2), for catching particles.

### BACKGROUND OF THE INVENTION

1. Field of the Invention

The present invention relates to a trash receiving structure for a shredder configured to shred sheet-like objects such as a paper sheet, and also relates to a shredder using the trash receiving structure.

2. Description of the Related Art

As shredders of this type in the related art, shredders as disclosed in Japanese Patent Application Laid-open No. H05-192602 (Embodiments and FIG. 1) and Japanese Patent No. 3059094 (Embodiment Modes of the Invention and FIG. 1) have already been known.

In the shredder disclosed in Japanese Patent Application Laid-open No. H05-192602 (Embodiments and FIG. 1), a feed port for paper sheets is formed at an inclination through a shredder body, and the paper sheets fed through the feed port are guided to shredder roller cutters by the feed rollers and guide plates. A cabin is formed below the shredder roller cutters. In this cabin, a box-shaped receiving container is arranged in a freely removable manner, and a trash bag is received therein. With this, particles generated through shredding by the shredder roller cutters are received by falling in the trash bag in the receiving container.

Japanese Patent No. 3059094 (Embodiment Modes of the Invention and FIG. 1) discloses a trash receiving plate for a shredder in which a shredding machine is fixed to an uppermost stage of a drawer-type cabinet formed of a frame assembly, a drawer immediately below the shredding machine is used as a trash box, and a flat plate is placed in a freely removable manner on edge portions of a horizontal frame of the frame assembly so that an opening portion at a center of the horizontal frame is closed.

However, in the related art disclosed in Japanese Patent Application Laid-open No. H05-192602 (Embodiments and FIG. 1), although the box-shaped receiving container is arranged in the cabin, there is a risk in that the particles generated through shredding by the shredder roller cutters are scattered to an outside of the receiving container without falling into the receiving container. In such a situation, at the time of drawing out the receiving container from the cabin, particles scattered on a bottom surface of the cabin are scattered to an outside of the cabin along with the operation of drawing out the receiving container. As a result, in many cases, the particles scattered around the shredder need to be cleaned off afterward.

Meanwhile, in the related art disclosed in Japanese Patent No. 3059094 (Embodiment Modes of the Invention and FIG. 1), the trash receiving plate is arranged below the drawer-type trash box. Thus, even when particles are scattered to an outside of the trash box, those scattered particles fall onto the trash receiving plate. With this, the problem in the related art as disclosed in Japanese Patent Application Laid-open No. H05-192602 (Embodiments and FIG. 1) can be solved.

However, in the related art disclosed in Japanese Patent No. 3059094 (Embodiment Modes of the Invention and FIG. 1), the trash receiving plate doubles as a support member for supporting the trash box. Thus, unless the trash box is drawn out, the trash receiving plate cannot be removed from the cabinet. In this way, there is a problem in that the particles accumulated on the trash receiving plate cannot be efficiently cleaned off. Further, when the trash receiving plate is removed from the cabinet, the trash box and the trash receiving plate are not present in the cabinet. In this situation, there is a risk in that particles adhering to the shredding machine fall into a storage box that is separately arranged below the trash box.

### SUMMARY OF THE INVENTION

It is a technical object of the present invention to prevent, during a post-process on particles generated through shredding by a shredding mechanism, the particles from being scattered to the surroundings, thereby facilitating the post-process on the particles.

According to a first technical feature of the present invention, there is provided a trash receiving structure for a shredder, including: a shredder casing including: a shredding mechanism built in the shredder casing, for shredding a sheet-like object; and a trash container set below the shredding mechanism, for receiving particles generated through shredding by the shredding mechanism; a partition frame member fixed above a bottom portion of the shredder casing to be separated therefrom, the partition frame member including a plurality of beams assembled to each other with clearances secured between the plurality of beams to define a setting space for the trash container, the partition frame member being configured such that the trash container is set thereon to be insertable to and removable from the shredder casing; and a tray-like catching member set to be insertable to and removable from a space portion between the bottom portion of the shredder casing and the partition frame member, for catching particles that fail to be received in the trash container.

According to a second technical feature of the present invention, in the trash receiving structure for a shredder having the first technical feature, the partition frame member is assembled into a shape of one of parallel crosses and a lattice.

According to a third technical feature of the present invention, in the trash receiving structure for a shredder having the first technical feature, the partition frame member is removable from the shredder casing.

According to a fourth technical feature of the present invention, in the trash receiving structure for a shredder having the first technical feature, the plurality of beams of the partition frame member each have a cross-section of a curved surface projecting upward on at least a setting side of the trash container.

According to a fifth technical feature of the present invention, in the trash receiving structure for a shredder having the first technical feature, the partition frame member comprises projecting portions that project outward on both sides in a width direction intersecting with an insertion-and-removal direction of the trash container, and the shredder casing comprises supports formed on both side walls in the width direction of the shredder casing, for supporting the projecting portions.

According to a sixth technical feature of the present invention, in the trash receiving structure for a shredder having the fifth technical feature, the projecting portions of the partition frame member are each formed of parts of the plurality of beams, and wherein the projecting portions are supported through engagement with positioning holes of the supports, which allow the projecting portions to be positioned in the insertion-and-removal direction of the trash container.

According to a seventh technical feature of the present invention, in the trash receiving structure for a shredder having the first technical feature, the shredder casing comprises holding supports for positioning and holding lower portions of peripheral walls of the trash container, the holding supports being formed at least on parts of peripheral walls of the shredder casing, which are located above the partition frame member and are located on both sides in a width direction of the trash container.

According to a eighth technical feature of the present invention, in the trash receiving structure for a shredder having the first technical feature, the shredder casing comprises inclined portions that are inclined obliquely downward toward lower portions of peripheral walls of the trash container, the inclined portions being formed on parts of peripheral walls of the shredder casing, which are located above the partition frame member.

According to a ninth technical feature of the present invention, there is provided a shredder, including: a shredding mechanism for shredding a sheet-like object; a trash container for receiving particles generated through shredding by the shredding mechanism; a shredder casing having the shredding mechanism built therein and the trash container set below the shredding mechanism; a partition frame member fixed above a bottom portion of the shredder casing to be separated therefrom, the partition frame member comprising a plurality of beams assembled to each other with clearances secured between the plurality of beams to define a setting space for the trash container, the partition frame member being configured such that the trash container is set thereon to be insertable to and removable from the shredder casing; and a tray-like catching member set to be insertable to and removable from a space portion between the bottom portion of the shredder casing and the partition frame member, for catching particles that fail to be received in the trash container.

According to a tenth technical feature of the present invention, in the shredder having the ninth technical feature, the tray-like catching member comprises a projecting part that projects toward an access port side of the shredder casing for the trash container with respect to the trash container set on the partition frame member when the tray-like catching member is set in the space portion in the shredder casing, and the projecting part comprises an insertion-and-removal handle.

According to the first technical feature of the present invention, the particles generated through the shredding by the shredding mechanism can be prevented from being scattered to the surroundings during the post-process on the particles, thereby facilitating the post-process on the particles.

According to the second technical feature of the present invention, a partition frame member having a high surface rigidity can be manufactured through simple assembly.

According to the third technical feature of the present invention, in comparison with an aspect in which the configuration of the present invention is not provided, even when the particles and the like electrostatically adhere to the partition frame member, the partition frame member can be easily cleaned by being removed from the shredder casing.

According to the fourth technical feature of the present invention, the particles are less liable to adhere to the partition frame member in comparison with the aspect in which the configuration of the present invention is not provided.

According to the fifth technical feature of the present invention, the partition frame member can be set in the shredder casing easily in comparison with the aspect in which the configuration of the present invention is not provided.

According to the sixth technical feature of the present invention, under a state in which the partition frame member is positioned in the insertion-and-removal direction of the trash container in the shredder casing, the partition frame member can be set easily in comparison with the aspect in which the configuration of the present invention is not provided.

According to the seventh technical feature of the present invention, in comparison with the aspect in which the configuration of the present invention is not provided, the trash container can be positioned and held at a predetermined position on the partition frame member.

According to the eighth technical feature of the present invention, in comparison with the aspect in which the configuration of the present invention is not provided, the particles that are scattered without being received in the trash container can be regulated and guided into the catching member.

According to the ninth technical feature of the present invention, it is possible to provide a shredder capable of preventing during the post-process on the particles generated through the shredding by the shredding mechanism the particles from being scattered to the surroundings, thereby facilitating the post-process on the particles.

According to the tenth technical feature of the present invention, the catching member can be easily inserted and removed independently of the trash container.

### BRIEF DESCRIPTION OF THE DRAWINGS

FIG. 1A is an explanatory view of an outline of a shredder having a trash receiving structure according to an embodiment of the present invention.

FIG. 1B is an explanatory view of a main part of the trash receiving structure of the shredder according to the embodiment of the present invention.

FIG. 2 is an explanatory view of an overall configuration of a shredder according to a first embodiment of the present invention.

FIG. 3A is an explanatory view of a control system of the shredder according to the first embodiment.

FIG. 3B is an explanatory view of an example of a drive device for the shredder.

FIG. 4 is an explanatory view of an outline of the trash receiving structure to be used in the shredder according to the first embodiment.

FIG. 5 is an explanatory view of a main part of the trash receiving structure illustrated in FIG. 4.

FIG. 6A is an explanatory view of a partition frame member and a support portion for a partition frame member in a shredder casing, which are separated from each other, in the trash receiving structure illustrated in FIG. 5.

FIG. 6B is an explanatory view of a main part of the support portion for the partition frame member.

FIG. 7A is a schematic explanatory plan view of a positional relationship between the partition frame member and the trash receiving tray in the shredder casing.

FIG. 7B is an explanatory view of a state in which a trash container is set in the shredder casing.

FIG. 8A is an explanatory plan view of a shape of the partition frame member according to the first embodiment.

FIGS. 8B and 8C are each an explanatory plan view of a modification of the shape of the partition frame member according to the first embodiment.

FIG. 9 is a schematic explanatory view of how a post-process on particles is executed in the trash receiving structure for the shredder according to the first embodiment.

### DETAILED DESCRIPTION OF THE PREFERRED EMBODIMENT

Outline of Embodiment of Present Invention

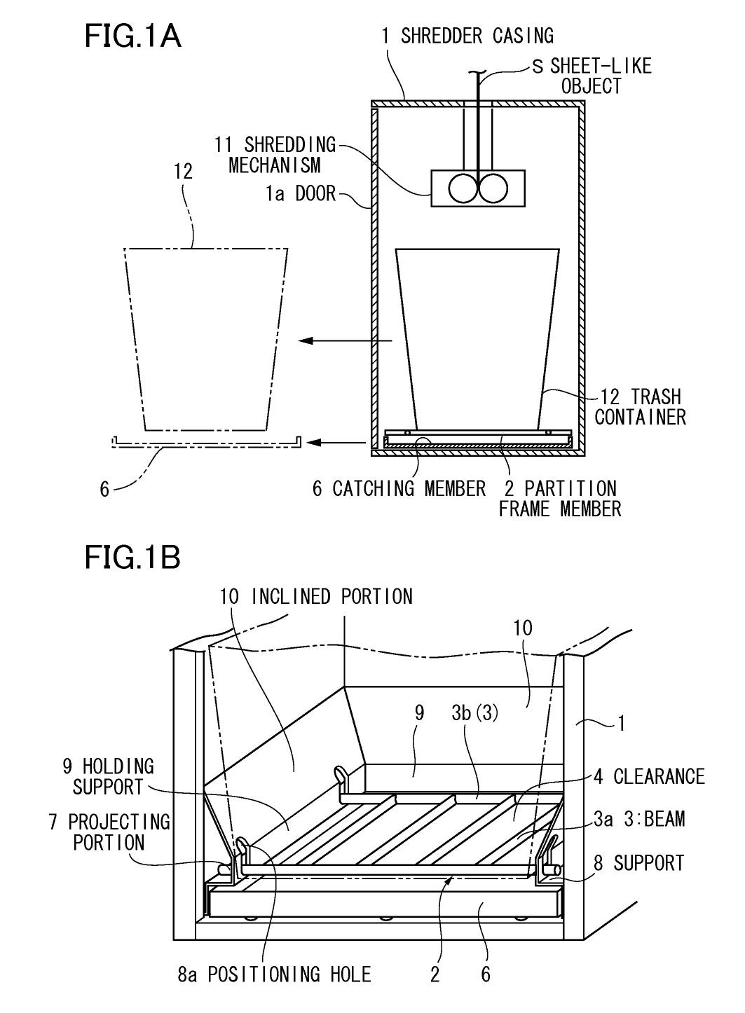

FIG. 1A illustrates an outline of a shredder according to an embodiment of the present invention.

In FIG. 1A, the shredder includes a shredding mechanism 11 for shredding a sheet-like object S, a trash container 12 for receiving particles generated through shredding by the shredding mechanism 11, and a shredder casing 1 in which the shredding mechanism 11 is installed and the trash container 12 is arranged below the shredding mechanism 11. In this shredder casing 1, a predetermined trash receiving structure is provided.

In this embodiment, as illustrated in FIGS. 1A and 13, the trash receiving structure for the shredder includes the shredder casing 1, a partition frame member 2, and a tray-like catching member 6. The partition frame member 2 is fixed above a bottom portion of the shredder casing 1 to be separated therefrom, and includes a plurality of beams 3 assembled to each other with clearances 4 secured therebetween to define a setting space for the trash container 12 for receiving the particles generated through the shredding by the shredding mechanism 11. Further, the partition frame member 2 is configured such that the trash container 12 is set thereon to be insertable to and removable from the shredder casing 1. The catching member 6 catches particles that are not received in the trash container 12. The catching member 6 is set to be insertable to and removable from a space portion between the bottom portion of the shredder casing 1 and the partition frame member 2.

In such technical means, in view of shredding the particles into a smaller size, it is preferred that the shredding mechanism 11 have a function capable of performing shredding in two directions. Specifically, a plurality of cutter elements may be used in combination, or a single cutter element may have a function of performing the shredding in the two directions (what is called a cross-cutter).

Further, a box-shaped container is typically used as the trash container 12, but any other shape such as a bag shape may be employed as long as the particles can be received therein.

Still further, any shredder casing 1 may be selected as appropriate as long as the shredding mechanism 11 is installed and the trash container 12 is set therein. In general, the shredder casing 1 includes an opening/closing door 1a that allows the trash container 12 to be inserted and removed.

Yet further, the partition frame member 2 is only required to be fixed above the bottom portion of the shredder casing 1 to be separated therefrom. In general, the partition frame member 2 is supported by parts of side walls of the shredder casing 1 or brackets mounted separately to the shredder casing 1. Such a support structure for the partition frame member 2 may be fixed to a predetermined position, or supported in a removable manner.

Note that, a form of the partition frame member 2 is not particularly limited as long as the plurality of beams 3 (in this embodiment, beams 3a extending in an insertion-and-removal direction of the trash container 12, and beams 3b extending in a width direction of the shredder casing 1, which intersects with the beams 3a) are assembled to each other with the clearances 4 secured therebetween, and a frame having a surface rigidity sufficient to support at least the trash container 12 when the particles are received is formed. Further, a size of the clearances 4 between the plurality of beams 3 may be selected as appropriate as long as the particles that fall when the trash container 12 is not set or the particles that are not received in the trash container 12 can pass therethrough. However, in order that the particles can easily pass therethrough, it is preferred that larger clearances 4 be secured.

Further, the catching member 6 is only required to utilize the space portion between the bottom portion of the shredder casing 1 and the partition frame member 2 so that the catching member 6 is arranged to be insertable thereto and removable therefrom. Specifically, the catching member 6 may be simply placed on the bottom portion of the shredder casing 1, or a guide member (not shown) may be fixed to the bottom portion of the shredder casing 1 so that the catching member 6 is moved to be insertable and removable along the guide member. Further, as a matter of course, in a case where the bottom portion of the shredder casing 1 is thick, drawers such as a small tray may be additionally arranged. Note that, any catching member 6 may be selected as appropriate as long as the “particles that are not received in the trash container 12” are caught thereby.

Next, description is made of typical examples and preferred examples of the trash receiving structure for the shredder.

First, as a typical example of the partition frame member 2, there is given a frame having a shape of have parallel crosses or a lattice.

Further, as a preferred example of the partition frame member 2, there is given a configuration in which the partition frame member 2 is removable from the shredder casing 1. According to this example, in a case where the partition frame member 2 is removable, even when the particles and the like electrostatically adhere to the partition frame member 2, the partition frame member 2 can be easily cleaned by being removed from the shredder casing 1.

Still further, as another preferred example of the partition frame member 2, there is given a configuration in which the beams 3 each have a cross-section of a curved surface projecting upward on at least a setting side of the trash container 12. As described in this embodiment, bar members each having a circular cross-section are typically used as the beams 3 of the partition frame member 2. However, the present invention is not limited thereto as long as a curved surface portion having the cross-section of the curved surface projecting upward is formed on the setting side of the trash container 12. This example is preferred in that the particles, which fall onto the beams 3 of the partition frame member 2, easily fall toward the catching member 6 side along the curved surface portions of the beams 3 due to low frictional resistance between the particles and the curved surface portions.

Further, as a typical example of the support structure for the partition frame member 2, as illustrated in FIG. 1B, the partition frame member 2 includes projecting portions 7 that project outward on both sides in the width direction intersecting with the insertion-and-removal direction of the trash container 12, and supports 8 for supporting the projecting portions 7 are arranged on both the side walls in the width direction of the shredder casing 1. In this example, in the partition frame member 2, the projecting portions 7 are arranged as portions to be supported at least on both the sides in the width direction intersecting with the insertion-and-removal direction of the trash container 12, and the supports 8 are fixed on a peripheral wall side of the shredder casing 1 so that the projecting portions 7 of the partition frame member 2 are supported by the supports 8.

Still further, as a preferred example of the support structure for the partition frame member 2 of this type, there is given a configuration in which the projecting portions 7 of the partition frame member 2 are formed of parts of the beams 3, and supported through engagement with positioning holes 8a of the supports 8, which allow the projecting portions 7 to be positioned in the insertion-and-removal direction of the trash container 12. In this example, the configuration of engaging the beams 3 as the projecting portions 7 with the positioning holes 8a is employed as the support structure for the partition frame member 2.

Further, as a preferred example of the shredder casing 1, there is given a configuration in which holding supports 9 for positioning and holding lower portions of peripheral walls of the trash container 12 are formed at least on parts of peripheral walls of the shredder casing 1, which are located above the partition frame member 2 and are located on both the sides in the width direction of the trash container 12.

In this example, the holding supports 9 are formed on the peripheral walls of the shredder casing 1 so that the trash container 12 is positioned and held by the holding supports 9. Note that, when the holding supports 9 are formed on both the sides in the width direction of the trash container 12, the trash container 12 is positioned in the width direction. Further, when another holding support 9 is formed on a depth side of the shredder casing 1, the trash container 12 is positioned and held also in the insertion-and-removal direction of the trash container 12.

Still further, as another preferred example of the shredder casing 1, there is given a configuration in which inclined portions 10 that are inclined obliquely downward toward the lower portions of the peripheral walls of the trash container 12 are formed on the parts of the peripheral walls of the shredder casing 1, which are located above the partition frame member 2.

In this example, even when the particles that are not received in the trash container 12 fall downward along the peripheral walls of the shredder casing 1, the particles are guided downward into the catching member 6 along the inclined portions 10.

Further, as a preferred example of the catching member 6, there is given a configuration in which the catching member 6 includes a projecting part that projects toward an access port side of the shredder casing 1 for the trash container 12 with respect to the trash container 12 set on the partition frame member 2 when the catching member 6 is set in the space portion in the shredder casing 1, and the projecting part includes an insertion-and-removal handle (not shown).

Note that, under a state in which both the trash container 12 and the catching member 6 are set in the shredder casing 1, when a near side of the catching member 6 is projected with respect to the trash container 12 as in this example, by arranging the handle on the projecting part, the catching member 6 is easily inserted and removed independently of the trash container 12.

Now, description is made of the embodiment of the present invention in more detail with reference to the accompanying drawings.

### First Embodiment

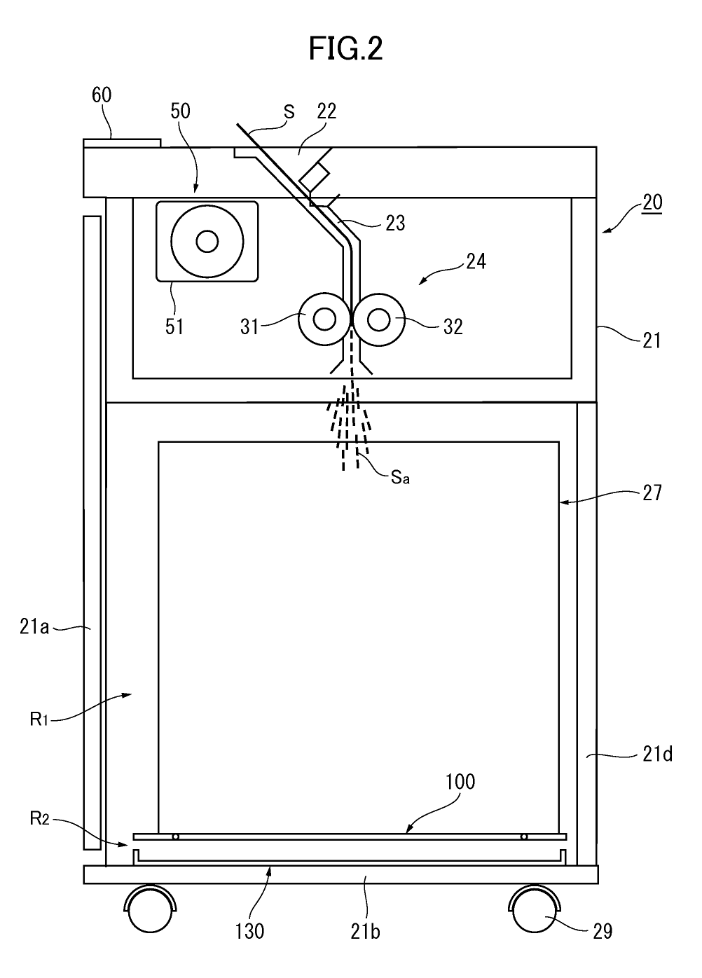

FIG. 2 illustrates an overall configuration of a shredder according to a first embodiment of the present invention.

—Overall Configuration of Shredder—

As illustrated in FIG. 2, a shredder 20 includes a shredder casing 21 having a substantially rectangular parallelepiped shape. A feed port 22 through which paper sheets S as sheet-like objects to be shredded are fed is opened in an upper surface of the shredder casing 21. A conveying path 23 defined by a pair of guide chutes is formed in the feed port 22. A shredding mechanism 24 is arranged in a midway of the conveying path 23. Below the shredding mechanism 24 in the shredder casing 21, a trash container 27 for receiving particles Sₐ of the paper sheets S is arranged to be removable from the shredder casing 21. Note that, a door 21a opens and closes the shredder casing 21, and casters 29 allow the shredder casing 21 to be freely moved.

Specifically, the shredding mechanism 24 employs a cross-cut type using blade drums 31 and 32 in a pair as cutter elements. With this, when the paper sheets S are inserted through a meshing region between the blade drums 31 and 32 in a pair, the paper sheets S are shredded simultaneously in both longitudinal and lateral directions, specifically, in a direction along a conveying direction of the paper sheets S (longitudinal direction) and a crossing direction substantially orthogonal thereto (lateral direction).

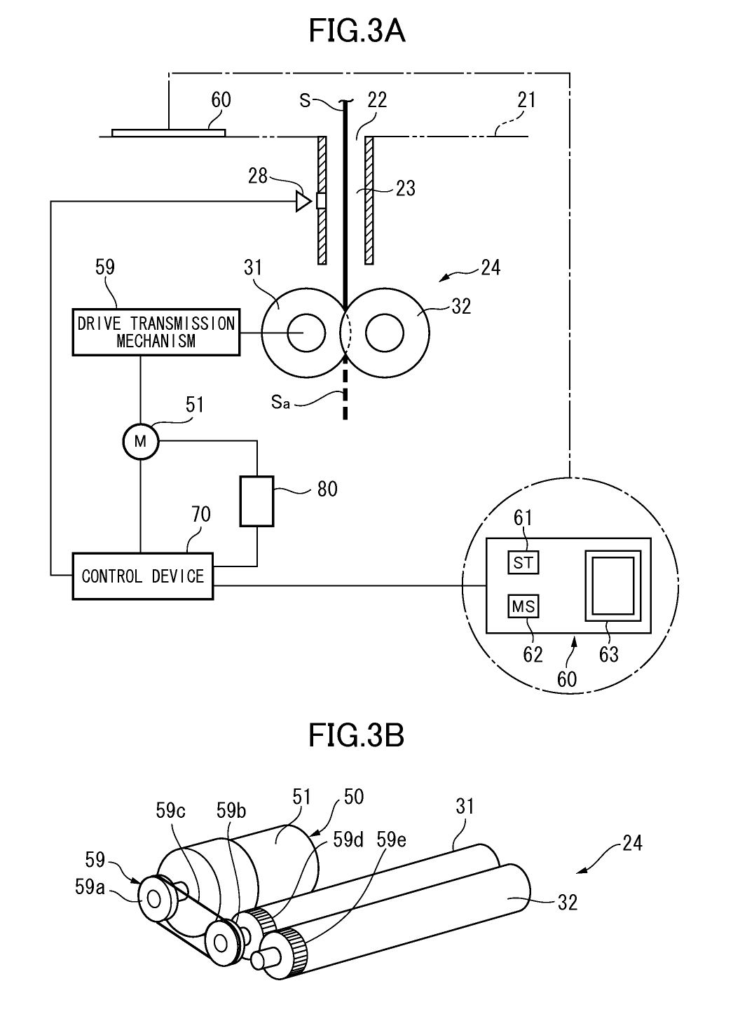

Further, in this embodiment, a drive device 50 drives the shredding mechanism 24. As illustrated in FIGS. 2, 3A, and 3B, the drive device 50 includes a drive motor 51 as a drive source, and a drive transmission mechanism 59 for transmitting a driving force from the drive motor 51 to the blade drums 31 and 32 in a pair of the shredding mechanism 24.

In this embodiment, the drive transmission mechanism 59 includes, for example, pulleys 59a and 59b fixed respectively to a drive shaft of the drive motor 51 and the rotary shaft of the first blade drum 31, and a transmission belt 59c looped around the pulleys 59a and 59b. Further, transmission gears 59d and 59e are engaged with each other and fixed to the rotary shafts of the blade drums 31 and 32 in a pair.

—Control Device—

Further, in this embodiment, as illustrated in FIG. 3A, the drive device 50 for driving the shredding mechanism 24 is controlled by a control device 70.

In this embodiment, the control device 70 has a microcomputer system including a CPU, a RAM, a ROM, and input/output ports. The control device 70 receives, for example, operation signals from an operation panel 60, and signals from a position sensor 28 for detecting whether or not the paper sheets S are conveyed in the conveying path 23 via the input/output ports. The control device 70 causes the CPU and the RAM to execute a shredding control program preinstalled in the ROM, to thereby transmit predetermined control signals to the drive device 50 for the shredding mechanism 24 via the input/output ports.

Note that, in this embodiment, as illustrated in FIG. 3A, the operation panel 60 includes a start switch 61 (abbreviated as “ST” in FIG. 3A) for turning on the shredder 20, a mode selection switch 62 (abbreviated as “MS” in FIG. 3A) for performing ON operations to specify, for example, a discharge mode for reversely discharging the paper sheets S in a case where the paper sheets S jam in the conveying path 23, and a display 63 for displaying operating conditions of the shredder 20. Further, as the position sensor 28, sensors of a mechanical type, an optical type, and other types may be selected as appropriate as long as passage of the paper sheets S can be detected.

Further, a current detector 80 detects drive current supplied to the drive motor 51. Through monitoring of a current value of the current detector 80, a load of the paper sheets S to be conveyed in the shredding mechanism 24 is determined. With this, a jam of the paper sheets S can be predicted. Note that, the load of the paper sheets S is determined by the current detector 80 in this embodiment. However, for example, a thickness detector (not shown) capable of detecting a thickness of the paper sheets S may be arranged in a midway of the conveying path 23 so that the load of the paper sheets S to be conveyed in the shredding mechanism 24 is determined through detection of the thickness by the thickness detector for the paper sheets S to be conveyed therein.

—Trash Receiving Structure—

In this embodiment, as described above, the trash container 27 is set in the shredder casing 21 of the shredder 20. As illustrated in FIGS. 2, 4, and 5, a predetermined trash receiving structure is arranged at a bottom portion of the shredder casing 21.

The trash receiving structure of the shredder 20 according to this embodiment includes a partition frame member 100 that is fixed above a bottom portion of the shredder casing 21 to be separated therefrom so as to define a space portion R₁ as a setting space for the trash container 27, and is configured such that the trash container 27 is set thereon to be insertable to and removable from the shredder casing 21, and a trash receiving tray 130 for catching the particles Sₐ that are not received in the trash container 27. The trash receiving tray 130 is set to be insertable to and removable from a space portion R₂ between the bottom portion of the shredder casing 21 and the partition frame member 100.

<Partition Frame Member>

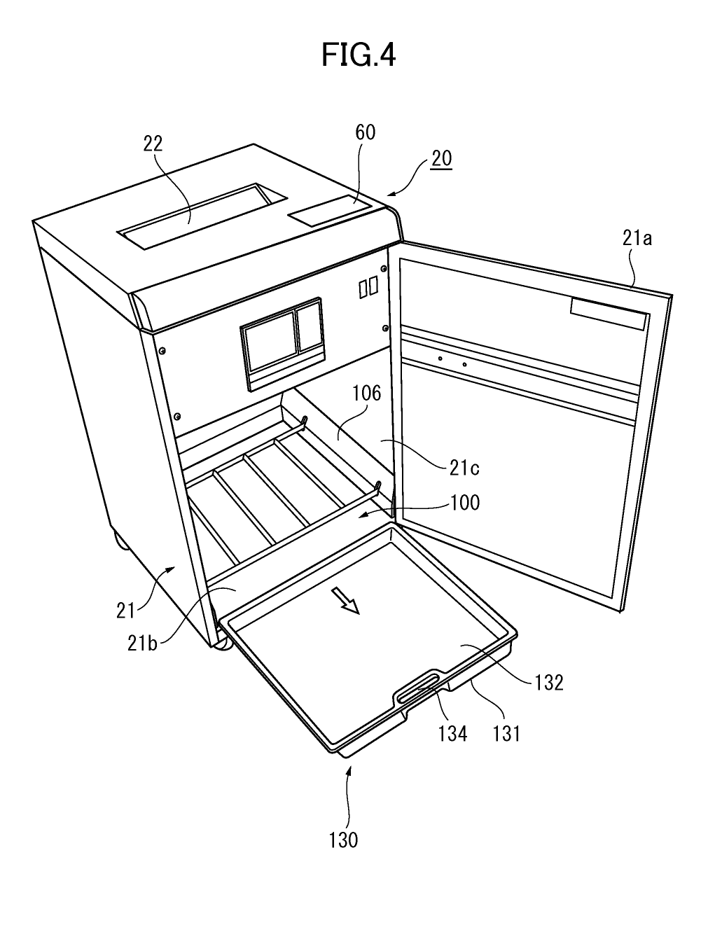

In this embodiment, the partition frame member 100 is formed by assembling a plurality of beams such as circular bars made of iron, SUS, or the like. Specifically, as illustrated in FIGS. 4 to 6 and 8A, a plurality of (four in this embodiment) first beams 101 extending in an insertion-and-removal direction of the trash container 27 are arrayed at predetermined intervals. A plurality of (two in this embodiment) second beams 102 extending in a width direction of the shredder casing 21, which intersects with the insertion-and-removal direction of the trash container 27, are arrayed at both ends of the first beams 101. In this embodiment, both the ends of each of the first beams 101 are joined, for example, by welding to the second beams 102 to form parallel crosses.

Further, in this embodiment, large clearances 104 are secured between the first beams 101 and the second beams 102, and the plurality of first beams 101 are bridged between the second beams 102 in a pair. The second beams 102 include projecting portions 105 that are projected outward in a longitudinal direction with respect to the first beams 101 that are bridged at outermost positions.

Note that, a length of each of the second beams 102 of the partition frame member 100 is not particularly limited as long as the length is at least larger than a dimension between opposed holding pieces 109 of support brackets 106, and may be selected as appropriate within a range smaller than a width dimension between both side walls 21c of the shredder casing 21. The partition frame member 100 is adjustable in position in the width direction of the shredder casing 21 by a length corresponding to a projecting dimension of each of the projecting portions 105 of the second beams 102.

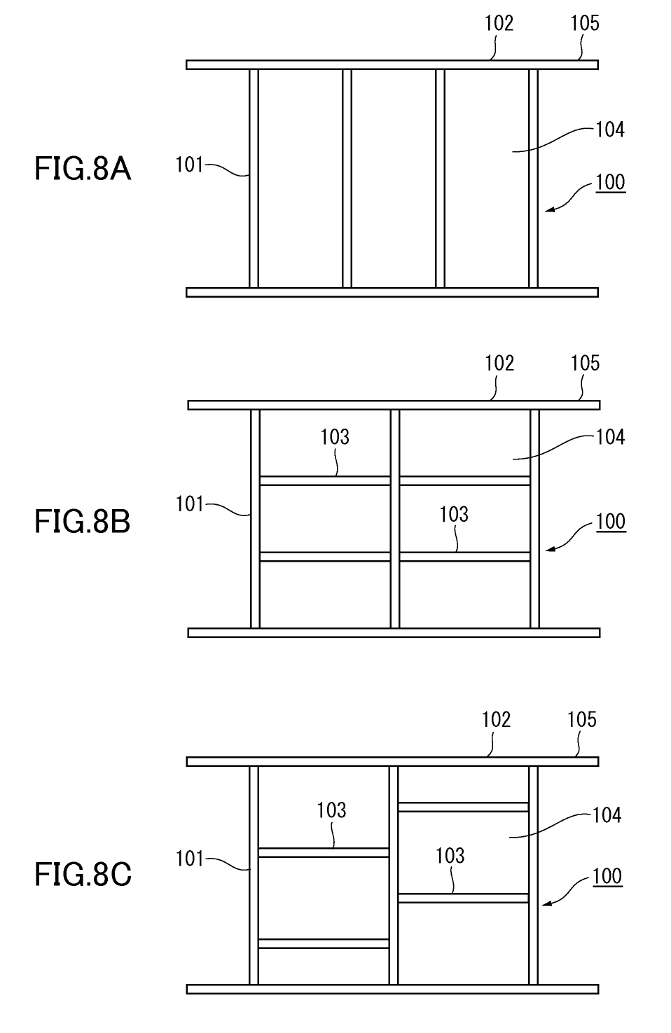

Note that, the configuration of the partition frame member 100 is not limited to that illustrated in FIG. 8A. For example, as illustrated in FIG. 8B, in addition to an assembly of a plurality of (three in this embodiment) first beams 101 and a plurality of (two in this embodiment) second beams 102, third beams 103 may be bridged in a lattice pattern between the first beams 101. Alternatively, as illustrated in FIG. 8C, in addition to the assembly of the first beams 101 and the second beams 102, the third beams 103 are bridged at different positions between the first beams 101. Still alternatively, in addition to the assembly of the first beams 101 and the second beams 102, fourth beams (not shown) may be bridged in directions of intersecting with both the first beams 101 and the second beams 102. In this way, various patterns may be selected as appropriate.

<Structure of Support Portion for Partition Frame Member>

Further, the support brackets 106 for supporting the partition frame member 100 are oppositely fixed respectively to vicinities of bottom portions of the inner surfaces of the side walls 21c located on both sides in the width direction of the shredder casing 21.

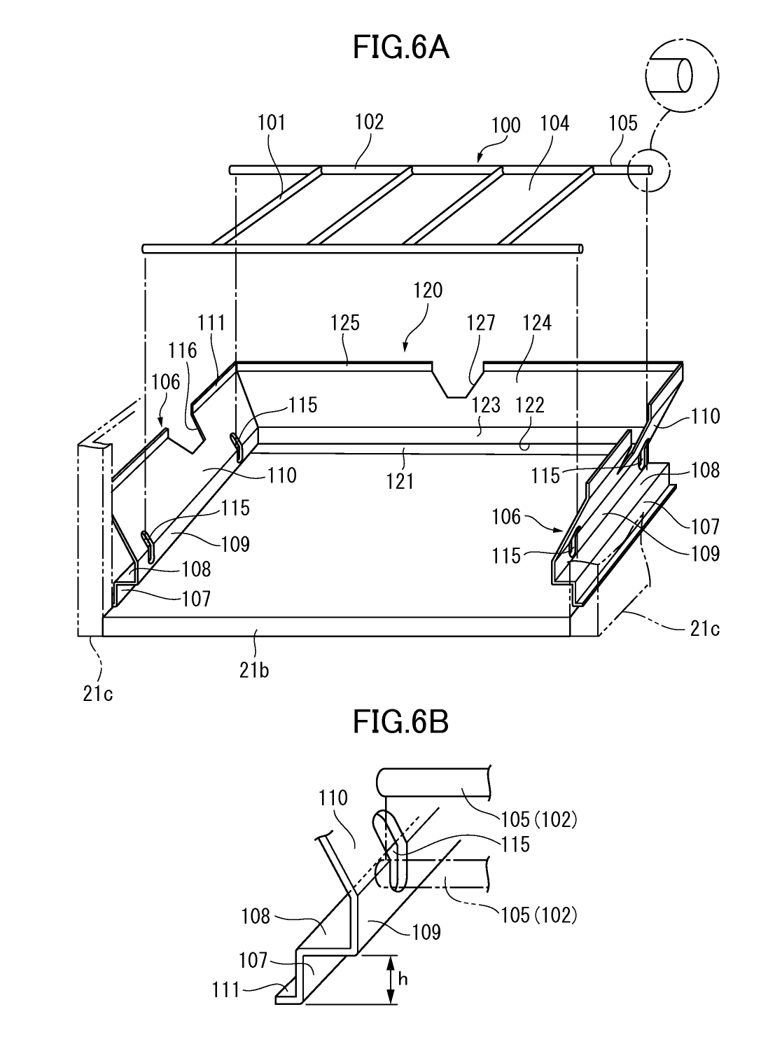

In this embodiment, the support brackets 106 are each formed of a plate member made of a metal such as aluminum and SUS. The support brackets 106 respectively include spacers 107 being arranged near the inner surfaces of the side walls 21c of the shredder casing 21 and each extending upward substantially in a vertical direction by a predetermined distance h (refer to FIG. 6B) to be separated from a bottom wall 21b of the shredder casing 21, support pieces 108 formed by bending upper portions of the spacers 107 substantially in a horizontal direction to be separated from the side walls 21c of the shredder casing 21, the holding pieces 109 formed by bending upward distal end portions of the support pieces 108 substantially in the vertical direction, inclined pieces 110 formed by bending upper portions of the holding pieces 109 obliquely upward toward the inner surfaces of the side walls 21c of the shredder casing 21, and mounting flanges 111 formed along lower edges of the spacers 107 and upper edges of the inclined pieces 110. The support brackets 106 are fixed by welding the mounting flanges 111 to an inner surface of the bottom wall 21b and the inner surfaces of the side walls 21c of the shredder casing 21.

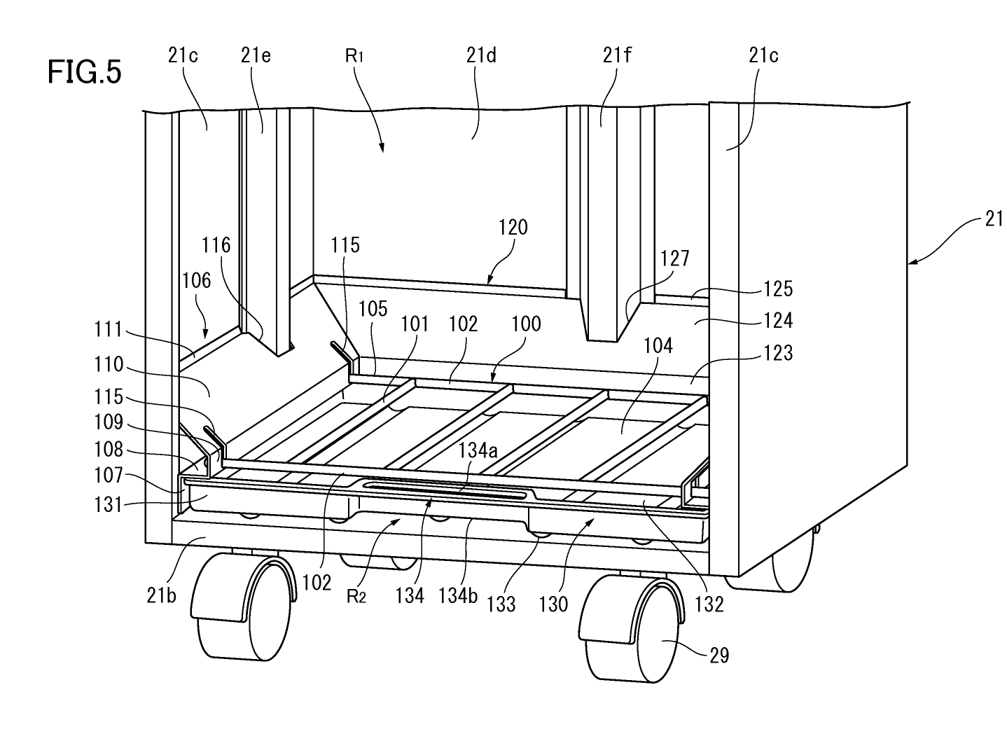

Further, in this embodiment, as illustrated in FIGS. 5, 6A, and 6B, positioning holes 115 to which the projecting portions 105 of the partition frame member 100 can be inserted are cut in the holding pieces 109 of the support brackets 106 and in the inclined pieces 110 on the holding piece 109 side. With this, after being inserted to the positioning holes 115 of the support brackets 106, the projecting portions 105 of the partition frame member 100 are placed on the support pieces 108.

Note that, cutouts 116 are formed by cutting out parts of the support brackets 106, which correspond to support posts 21e for securing a strength of the shredder casing 21.

<Holding Structure for Trash Container>

In this embodiment, in a vicinity of a bottom portion of an inner surface of a depth side wall 21d located on a depth side of the shredder casing 21, a position regulating plate 120 for regulating a setting position of the trash container 27 is arranged.

The position regulating plate 120 includes a spacer 121 being arranged near the inner surface of the depth side wall 21d of the shredder casing 21 and extending upward substantially in the vertical direction by the predetermined distance h to be separated from the bottom wall 21b of the shredder casing 21, a bent piece 122 formed by bending an upper portion of the spacer 121 substantially in the horizontal direction to be separated from the depth side wall 21d of the shredder casing 21, a holding piece 123 formed by bending upward a distal end portion of the bent piece 122 substantially in the vertical direction, an inclined piece 124 formed by bending an upper portion of the holding piece 123 obliquely upward toward the inner surface of the depth side wall 21d of the shredder casing 21, and mounting flanges 125 formed respectively along a lower edge of the spacer 121 and an upper edge of the inclined piece 124. The position regulating plate 120 is fixed by welding the mounting flanges 125 to the inner surface of the bottom wall 21b and the inner surface of the depth side wall 21d of the shredder casing 21.

Note that, a cutout 127 is formed by cutting out a part of the position regulating plate 120, which corresponds to a support post 21f for securing the strength of the shredder casing 21.

In this embodiment, the partition frame member 100 is supported by the support brackets 106, and the trash container 27 is set on the partition frame member 100.

At this time, a bottom portion of the trash container 27 is held by the holding pieces 109 of the support brackets 106 and by the holding piece 123 of the position regulating plate 120. The trash container 27 is positioned in the width direction of the shredder casing 21, which intersects with the insertion-and-removal direction of the trash container 27. Further, on the depth side of the shredder casing 21, the trash container 27 is regulated in position in the insertion-and-removal direction of the trash container 27.

<Trash Receiving Tray and Structure of Receiving Portion Therefor>

In this embodiment, the partition frame member 100 is supported by the support brackets 106 so that the space portion R₂ between the bottom wall 21b of the shredder casing 21 and the partition frame member 100 functions as a receiving portion in which the trash receiving tray 130 is received in an insertable and removable manner.

In this embodiment, as illustrated in FIGS. 4 to 7, the trash receiving tray 130 is integrally formed of a synthetic resin or a metal, and includes a tray body 131 having a bottom wall surrounded by peripheral wall portions. A recessed portion 132 of the tray body 131 functions as a catching portion for particles Sₐ. Further, on a bottom surface of the bottom wall of the tray body 131, a plurality of ribs 133 are formed to extend in the insertion-and-removal direction of the trash container 27, and a handle 134 is integrally formed substantially at a center of the tray body 131 on an access port side of the shredder casing 21. Note that, in this embodiment, the handle 134 includes an insertion recessed portion 134a to which the fingers of a user are inserted, and a cutout portion 134b formed by cutting out a bottom portion side of the peripheral wall portion of the tray body 131 so as to be easily held by the user.

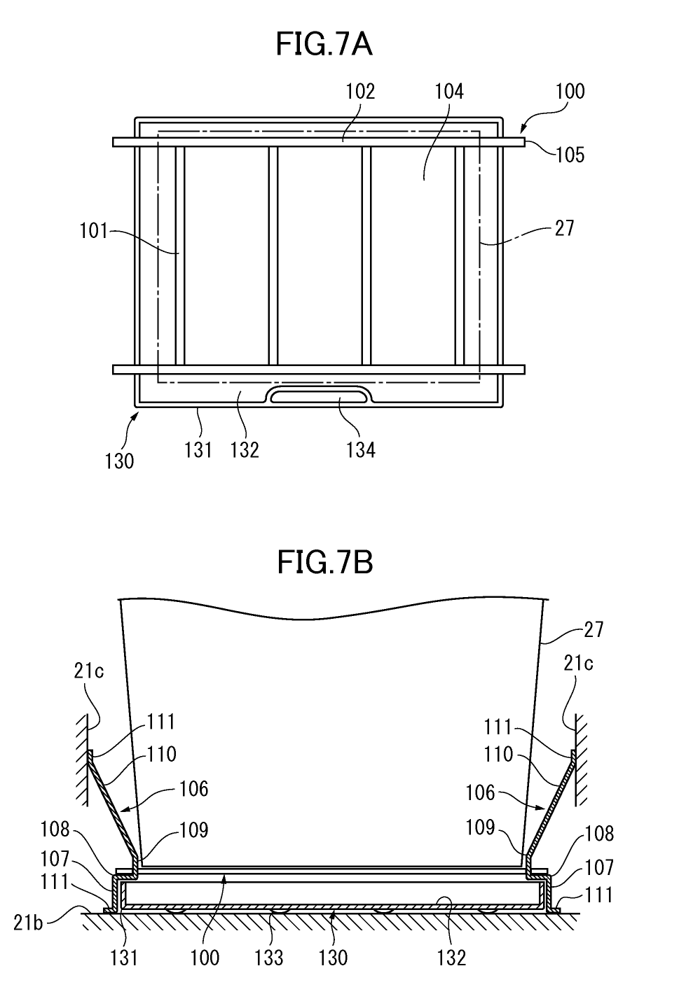

In addition, in this embodiment, as illustrated in FIG. 7A, an area of the recessed portion 132 of the trash receiving tray 130 is set to be larger than a setting area for the bottom portion of the trash container 27. The handle 134 of the trash receiving tray 130 is arranged to project toward the access port side of the shredder casing 21 with respect to the trash container 27 under a state in which the trash container 27 and the trash receiving tray 130 are set respectively in the space portions R₁ and R₂ in the shredder casing 21.

—Operation of Preparing Trash Receiving Structure for Shredder—

In this embodiment, at the time of operating the shredder 20, the trash receiving structure needs to be prepared in the shredder casing 21.

The preparation operation is performed, for example, as follows.

(1) Operation of Setting Partition Frame Member

First, as illustrated in FIG. 6A, the partition frame member 100 is set to the support brackets 106 of the shredder casing 21.

In this case, as illustrated in FIGS. 6A and 6B, the projecting portions 105 of the partition frame member 100 are only required to be inserted to the positioning holes 115 of the support brackets 106 so that the projecting portions 105 of the partition frame member 100 are supported by the support pieces 108 of the support brackets 106.

(2) Operation of Setting Trash Receiving Tray

As illustrated in FIG. 5, this operation is performed by inserting the trash receiving tray 130 to the space portion R₂ between the bottom wall 21b of the shredder casing 21 and the partition frame member 100.

(3) Operation of Setting Trash Container

In this operation, the trash container 27 is only required to be inserted to the space portion R₁ in the shredder casing 21 after the partition frame member 100 is set into the shredder casing 21 so that the trash container 27 is placed on the partition frame member 100.

At this time, the bottom portion of the trash container 27 is held by the holding pieces 109 of the support brackets 106 and by the holding piece 123 of the position regulating plate 120. The trash container 27 is positioned in the width direction of the shredder casing 21. Further, on the depth side of the shredder casing 21, the trash container 27 is regulated in position in the insertion-and-removal direction of the trash container 27.

—Shredding Control Process of Shredder—

Next, description is made of a shredding control process of the shredder according to this embodiment.

First, as illustrated in FIG. 3A, when the control device 70 determines that the ON operation has been performed via the start switch 61 of the operation panel 60, the control device 70 sets a predetermined driving condition as a driving condition of the drive device 50 (such as a driving speed condition of the drive motor 51).

In this state, when the paper sheets S are fed into the feed port 22 of the shredder casing 21, the paper sheets S are moved toward the shredding mechanism 24 along the conveying path 23. At this time, when the position sensor 28 detects the passage of the paper sheets S, the detection signal generated by the position sensor 28 is transmitted to the control device 70. In response thereto, the drive motor 51 drives the blade drums 31 and 32 in a pair in the shredding mechanism 24 in accordance with the predetermined driving condition.

In this embodiment, the paper sheets S are shredded simultaneously in the longitudinal and lateral directions by passing through the meshing region between the blade drums 31 and 32 in a pair. The particles Sₐ fall downward into the trash container 27.

Then, when a predetermined time period elapses after a trailing end of the paper sheet S passes by the position sensor 28 (time period in which completion of the shredding process is presumed), the control device 70 determines that the shredding process has been completed, and stops driving of the drive motor 51. With this, the serial shredding control process is completed.

—Behavior of Particles—

In this embodiment, most of the particles Sₐ generated through shredding by the shredding mechanism 24 are received by falling in the trash container 27.

However, there is a risk in that a part of the particles Sₐ is scattered and falls to positions out of the trash container 27.

In such a situation, when the particles Sₐ are scattered around the trash container 27, those particles Sₐ fall downward through clearance portions between the trash container 27 and the peripheral walls of the shredder casing 21. In this case, as illustrated in FIG. 7B, the particles S, reach the inclined pieces 110 of the support brackets 106 and the inclined piece 124 of the position regulating plate 120, and move downward along inclined surfaces thereof. Lastly, the particles Sₐ fall downward through clearance portions between the trash container 27 and the holding pieces 109 of the support brackets 106 or between the trash container 27 and the holding piece 123 of the position regulating plate 120, and are guided onto the trash receiving tray 130 through the clearances 104 of the partition frame member 100.

In this way, the inclined pieces 110 of the support brackets 106 and the inclined piece 124 of the position regulating plate 120 function as guide surfaces for catching and guiding downward the particles Sₐ. Thus, the particles Sₐ are likely to be sequentially guided onto the trash receiving tray 130 without being accumulated on the bottom portion side of the peripheral walls of the shredder casing 21.

—Post-Process on Particles—

<At Time of Drawing Out Trash Container>

Next, description is made of how the user executes a post-process on the particles Sₐ received in the trash container 27.

The user starts the post-process on the particles Sₐ voluntarily or when an alert indicating that the trash container 27 has been filled with the particles Sₐ is displayed on the display 63 of the operation panel 60.

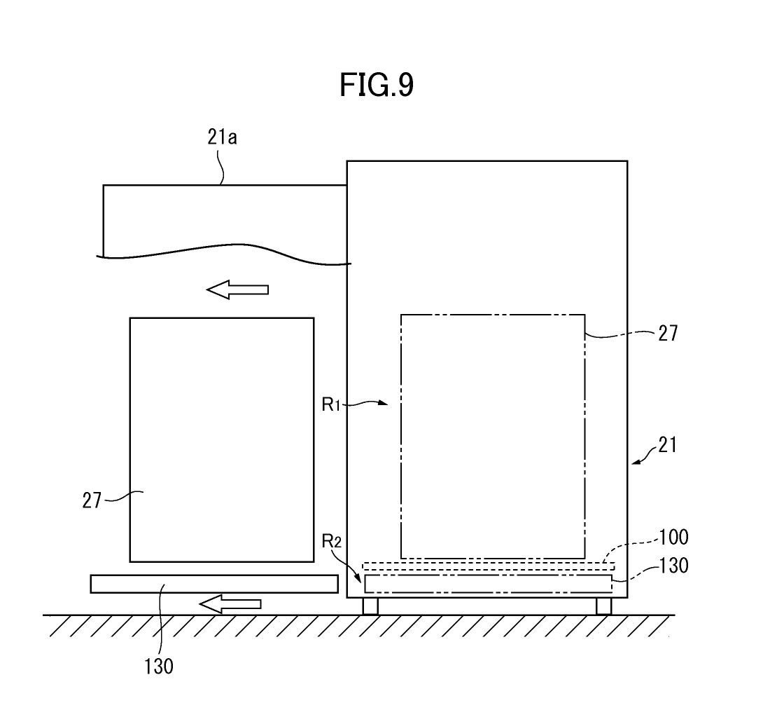

In this case, as illustrated in FIG. 9, the user is only required to open the door 21a of the shredder casing 21, and to draw out the trash container 27 to an outside of the shredder casing 21.

In such a situation, the trash container 27 is not set on the partition frame member 100. In a case where the shredder casing 21 is vibrated when the trash container 27 is drawn out, there is a risk of a fall of the particles Sₐ adhering to the shredding mechanism 24.

However, even when the particles Sₐ fall from the shredding mechanism 24, the trash receiving tray 130 is set in the bottom portion of the shredder casing 21, and hence the particles Sₐ thus fallen can be caught by the trash receiving tray 130.

Further, the partition frame member 100 is set above the trash receiving tray 130. The partition frame member 100 is formed by assembling the plurality of beams 101 and 102, and the large clearances 104 are formed between the beams 101 and 102. Thus, the particles Sₐ are less liable to be caught by parts of the beams 101 and 102, and hence most of the particles Sₐ fall onto the trash receiving tray 130 through the clearances 104.

In particular, in this embodiment, the beams 101 and 102 are each formed of a circular bar having a circular cross-section, and hence frictional resistance between the particles Sₐ and each of the beams 101 and 102 is low. Thus, even when the particles Sₐ come into contact with the beams 101 and 102, the particles Sₐ are likely to fall toward the trash receiving tray 130 side.

For this reason, even when the trash container 27 is drawn out, there is no risk in that the particles Sₐ that fall from the shredding mechanism 24 are accumulated on parts in the bottom portion of the shredder casing 21 other than the partition frame member 100 and the trash receiving tray 130.

<Cleaning Process on Trash Receiving Tray>

Now, in the situation where the trash container 27 is set on the partition frame member 100, for example, in a case where the post-process is executed on the particles Sₐ in the trash receiving tray 130, the post-process on the particles Sₐ in the trash receiving tray 130 is only required to be executed by drawing out the trash receiving tray 130 from the space portion R₂ in the shredder casing 21 as illustrated in FIG. 9.

At this time, as illustrated in FIG. 7A, the handle 134 of the trash receiving tray 130 is exposed on the near side with respect to the trash container 27 that is set in the shredder casing 21 (corresponding to the access port side of the shredder casing 21). Thus, the user can easily draw out the trash receiving tray 130 by gripping the handle 134. Further, in this embodiment, the ribs 133 extending in the insertion-and-removal direction of the trash container 27 are formed on the bottom surface of the tray body 131 of the trash receiving tray 130. Thus, sliding resistance between the trash receiving tray 130 and the bottom wall 21b of the shredder casing 21 is low, and hence operations of inserting and removing the trash receiving tray 130 can be facilitated.

<Cleaning Process on Partition Frame Member>

In this embodiment, the partition frame member 100 is removable from the support brackets 106. Thus, in a situation where the partition frame member 100 fouls, for example, with dust of the particles Sₐ, the partition frame member 100 that has been set in the shredder casing 21 can be temporarily removed. With this, the partition frame member 100 can be regularly cleaned.

What is claimed is:

1. A trash receiving structure for a shredder, comprising:
a shredder casing comprising:
a shredding mechanism built in the shredder casing, for shredding a sheet-like object; and
a trash container set below the shredding mechanism, for receiving particles generated through shredding by the shredding mechanism;
a partition frame member fixed above a bottom portion of the shredder casing to be separated therefrom, the partition frame member comprising a plurality of beams assembled to each other with clearances secured between the plurality of beams to define a setting space for the trash container, the partition frame member being configured such that the trash container is set thereon to be insertable to and removable from the shredder casing; and
a tray-like catching member set to be insertable to and removable from a space portion between the bottom portion of the shredder casing and the partition frame member, for catching particles that fail to be received in the trash container.

2. A trash receiving structure for a shredder according to claim 1, wherein the partition frame member is assembled into a shape of one of parallel crosses and a lattice.

3. A trash receiving structure for a shredder according to claim 1, wherein the partition frame member is removable from the shredder casing.

4. A trash receiving structure for a shredder according to claim 1, wherein the plurality of beams of the partition frame member each have a cross-section of a curved surface projecting upward on at least a setting side of the trash container.

5. A trash receiving structure for a shredder according to claim 1,
wherein the partition frame member comprises projecting portions that project outward on both sides in a width direction intersecting with an insertion-and-removal direction of the trash container, and
wherein the shredder casing comprises supports formed on both side walls in the width direction of the shredder casing, for supporting the projecting portions.

6. A trash receiving structure for a shredder according to claim 5,
wherein the projecting portions of the partition frame member are each formed of parts of the plurality of beams, and
wherein the projecting portions are supported through engagement with positioning holes of the supports, which allow the projecting portions to be positioned in the insertion-and-removal direction of the trash container.

7. A trash receiving structure for a shredder according to claim 1, wherein the shredder casing comprises holding supports for positioning and holding lower portions of peripheral walls of the trash container, the holding supports being formed at least on parts of peripheral walls of the shredder casing, which are located above the partition frame member and are located on both sides in a width direction of the trash container.

8. A trash receiving structure for a shredder according to claim 1, wherein the shredder casing comprises inclined portions that are inclined obliquely downward toward lower portions of peripheral walls of the trash container, the inclined portions being formed on parts of peripheral walls of the shredder casing, which are located above the partition frame member.

9. A shredder, comprising:
a shredding mechanism for shredding a sheet-like object;
a trash container for receiving particles generated through shredding by the shredding mechanism;
a shredder casing having the shredding mechanism built therein and the trash container set below the shredding mechanism;
a partition frame member fixed above a bottom portion of the shredder casing to be separated therefrom, the partition frame member comprising a plurality of beams assembled to each other with clearances secured between the plurality of beams to define a setting space for the trash container, the partition frame member being configured such that the trash container is set thereon to be insertable to and removable from the shredder casing; and
a tray-like catching member set to be insertable to and removable from a space portion between the bottom portion of the shredder casing and the partition frame member, for catching particles that fail to be received in the trash container.

10. A shredder according to claim 9,
wherein the tray-like catching member comprises a projecting part that projects toward an access port side of the shredder casing for the trash container with respect to the trash container set on the partition frame member when the tray-like catching member is set in the space portion in the shredder casing, and
wherein the projecting part comprises an insertion-and-removal handle.
